(19) United States
(12) Patent Application Publication
(10) Pub. No.: US 2025/0282222 A1
(43) Pub. Date: Sep. 11, 2025

(54) DISPLAY CONTROL DEVICE, DISPLAY CONTROL METHOD, AND NON-TRANSITORY COMPUTER-READABLE MEDIUM STORING DISPLAY CONTROL PROGRAM

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/026,808

(22) Filed: Jan. 17, 2025

(30) Foreign Application Priority Data
Mar. 7, 2024 (JP) 2024-035309

(51) Int. Cl. B60K 35/28

(52) U.S. Cl. CPC B60K 35/28; B60K 2360/168; B60K 2360/171; B60K 2360/178; B60K 2360/1868; B60K 2360/195; B60K 2360/31

(57) ABSTRACT

A display control device includes a control section that, on the basis of peripheral information relating to a peripheral situation of an own vehicle, displays, on a display section, images showing the own vehicle and the peripheral situation that are viewed from a virtual viewpoint, and, due to establishment of a predetermined condition, changes an image of a background that is displayed as an image showing the peripheral situation.

### CROSS-REFERENCE TO RELATED APPLICATION

This application claims priority under 35 USC 119 from Japanese Patent Application No. 2024-035309, filed on Mar. 7, 2024, the disclosure of which is incorporated by reference herein.

### BACKGROUND

### Technical Field

The present disclosure relates to a display control device, a display control method, and a non-transitory computer-readable medium storing a display control program.

### Related Art

Japanese Patent No. 7048398 discloses a vehicle control device that can carry out automatic driving that imparts a sense of security to the passengers.

In the technique relating to Japanese Patent No. 7048398, images showing the peripheral situation of the own vehicle are displayed on a display section (see FIG. 8 of Japanese Patent No. 7048398). Here, it is preferable that, of the images that show the peripheral situation, the image of the background that is displayed together with the image showing the own vehicle is switched appropriately to a suitable image in accordance with changes in the peripheral situation for example. However, Japanese Patent No. 7048398 does not disclosure switching of the image of the background, and there is room for improvement.

### SUMMARY

The present disclosure provides a display control device, a display control method, and a non-transitory computer-readable medium on which a display control program is recorded that can present an image of a background, which shows the peripheral situation of an own vehicle, to a passenger in plural forms.

A first aspect of the present disclosure is a display control device including: a control section that, on the basis of peripheral information relating to a peripheral situation of an own vehicle, displays, on a display section, images showing the own vehicle and the peripheral situation that are viewed from a virtual viewpoint, and, due to establishment of a predetermined condition, changes an image of a background that is displayed as an image showing the peripheral situation.

In the display control device according to the first aspect, on the basis of the peripheral information that relates to the peripheral situation of the own vehicle, the control section displays, on the display section, images showing the own vehicle and the peripheral situation that are viewed from a virtual viewpoint. Further, the control section changes the image of a background, which is displayed as an image showing the peripheral situation, due to the establishment of a predetermined condition. Due thereto, in accordance with this display control device, by changing the image of a background that shows the peripheral situation of the own vehicle due to the establishment of a predetermined condition, the image of a background may be presented to the passenger in the plural forms of before and after the changing thereof.

In a second aspect of the present disclosure, in the first aspect, due to establishment of the predetermined condition that is based on at least one of a traveling place or a state of the own vehicle, the control section may change the image of a background that is displayed on the display section, and may change the virtual viewpoint in accordance with the changed image of a background.

In the display control device according to the second aspect, the control section changes the image of a background, which is displayed on the display section, due to the establishment of a predetermined condition that is based on at least one of the traveling place and the state of the own vehicle. Further, the control section changes the virtual viewpoint in accordance with the changed image of a background. Due thereto, in accordance with this display control device, a road image, which is viewed from a virtual viewpoint that is thought to be suitable in accordance with at least one of the traveling place and the state of the own vehicle, may be presented to the passenger.

In a third aspect of the present disclosure, in the first or the second aspect, due to establishment of the predetermined condition that is based on a selection by a passenger of the own vehicle, the control section may change the image of a background that is displayed on the display section, and may switch displaying/non-displaying of images of individual targets that are displayed as images showing the peripheral situation.

In the display control device according to the third aspect, the control section changes the image of a background, which is displayed on the display section, due to the establishment of a predetermined condition that is based on a selection by a passenger of the own vehicle. Further, due to the establishment of this predetermined condition, the control section switches the displaying/non-displaying of images of individual targets that are displayed as images showing the peripheral situation. Due thereto, in accordance with this display control device, a background and targets that correspond to the preferences of the passenger may be presented to the passenger.

In a fourth aspect of the present disclosure, in the third aspect, in a case in which images of a specific target have been switched to non-display, the control section may display, on the display section, caution information expressing that the images of the specific target are not displayed as images showing the peripheral situation.

In the display control device according to the fourth aspect, in a case in which images of a specific target have been switched to non-display, the control section displays, on the display section, caution information expressing that images of the specific target are not displayed as images showing the peripheral situation. Due thereto, in accordance with this display control device, even though images of a specific target are not displayed on the display section, the passenger may be made to pay attention to the specific targets that exist in the real space.

In a fifth aspect of the present disclosure, in the third of the fourth aspect, in a case in which a plurality of targets of a same type that exist within a predetermined range are detected, the control section may display on the display section only an image of a target, whose risk to the own vehicle exceeds a predetermined standard, among the plurality of targets.

In the display control device according to the fifth aspect, in a case in which plural targets of the same type, which exist within a predetermined range, are detected, the control section displays on the display section only the image of a target, whose risk to the own vehicle exceeds a predetermined standard, among the plural targets. Due thereto, in accordance with this display control device, the attention paid to a target, which exists in the real space and whose risk to the own vehicle exceeds a predetermined standard, may be increased.

In a sixth aspect of the present disclosure, in the above aspects, the display section may be a meter display provided at a vehicle front side of a driver's seat of the own vehicle.

In the display control device according to the sixth aspect, the display section is a meter display provided at the vehicle front side of the driver's seat of the own vehicle. Due thereto, in accordance with this display control device, information showing meters of the measuring instruments of the own vehicle, and images showing the own vehicle and the peripheral situation of the own vehicle, may be presented to the passenger in one screen.

A seventh aspect of the present disclosure is a display control method, comprising, by a computer: on the basis of peripheral information relating to a peripheral situation of an own vehicle, displaying, on a display section, images showing the own vehicle and the peripheral situation that are viewed from a virtual viewpoint; and due to establishment of a predetermined condition, changing an image of a background that is displayed as an image showing the peripheral situation.

An eighth aspect of the present disclosure is a non-transitory computer-readable medium storing a display control program executed by a computer to perform processing comprising: on the basis of peripheral information relating to a peripheral situation of an own vehicle, displaying, on a display section, images showing the own vehicle and the peripheral situation that are viewed from a virtual viewpoint; and due to establishment of a predetermined condition, changing an image of a background that is displayed as an image showing the peripheral situation.

In accordance with the above-described aspects, the display control device, display control method and non-transitory computer-readable medium storing a display control program of the present disclosure may present an image of a background, which shows the peripheral situation of the own vehicle, to a passenger in plural forms.

### BRIEF DESCRIPTION OF THE DRAWINGS

Exemplary embodiments will be described in detail based on the following figures, wherein:

FIG. 1 is a block drawing illustrating the schematic configuration of a vehicle;

FIG. 2 is a schematic drawing in which the front section of the vehicle cabin interior of the vehicle is seen from a vehicle rear side;

FIG. 3 is an explanatory drawing for explaining a display region of a first display section;

FIG. 4 is a block drawing illustrating the schematic configuration of a display control device;

FIG. 5 is a block drawing illustrating an example of functional configurations of the display control device;

FIG. 6 is flowchart illustrating the flow of specifying processing;

FIG. 7 is a first explanatory drawing illustrating a display example that is displayed in the display region of the first display section;

FIG. 8 is a second explanatory drawing illustrating a display example that is displayed in the display region of the first display section;

FIG. 9 is a third explanatory drawing illustrating a display example that is displayed in the display region of the first display section;

FIG. 10 is a fourth explanatory drawing illustrating a display example that is displayed in the display region of the first display section;

FIG. 11 is a fifth explanatory drawing illustrating a display example that is displayed in the display region of the first display section;

FIG. 12 is a sixth explanatory drawing illustrating a display example that is displayed in the display region of the first display section;

FIG. 13 is a seventh explanatory drawing illustrating a display example that is displayed in the display region of the first display section;

FIG. 14 is an eighth explanatory drawing illustrating a display example that is displayed in the display region of the first display section;

FIG. 15 is a ninth explanatory drawing illustrating a display example that is displayed in the display region of the first display section;

FIG. 16 is a tenth explanatory drawing illustrating a display example that is displayed in the display region of the first display section;

FIG. 17 is an eleventh explanatory drawing illustrating a display example that is displayed in the display region of the first display section;

FIG. 18 is a twelfth explanatory drawing illustrating a display example that is displayed in the display region of the first display section; and

FIG. 19 is a thirteenth explanatory drawing illustrating a display example that is displayed in the display region of the first display section.

### DETAILED DESCRIPTION

A vehicle 10 relating to present exemplary embodiments is described hereinafter.

### First Exemplary Embodiment

First, a first exemplary embodiment of the vehicle 10 relating to the present exemplary embodiments is described.

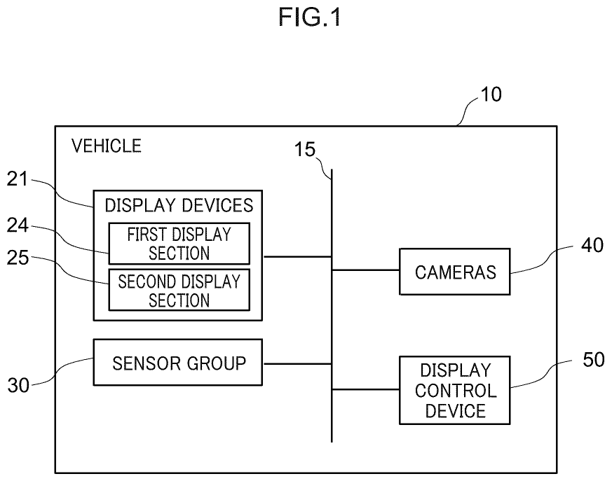

FIG. 1 is a block drawing illustrating the schematic configuration of the vehicle 10. As illustrated in FIG. 1, the vehicle 10 has display devices 21, a sensor group 30, cameras 40 and a display control device 50. The display devices 21, the sensor group 30, the cameras 40 and the display control device 50 are respectively connected via an external bus (communication bus) 15. The vehicle 10 is an example of the “own vehicle”.

The display devices 21 display proposals of operations relating to functions of the vehicle 10, and images relating to explanations of these functions, and the like. In the present exemplary embodiment, a first display section 24 and a second display section 25 are provided as the display devices 21. The first display section 24 is an example of the “display section”. Note that details of the first display section 24 and the second display section 25 are described hereinafter.

The sensor group 30 includes sensors for detecting the state and the peripheral situation of the vehicle 10 such as, for example, 3D-LiDAR, millimeter wave sensors, infrared sensors, the turn signal sensors, the accelerator position sensor, the shift position sensor, luminance sensors, the vehicle speed sensor, steering angle sensors, angular velocity sensors, GPS (Global Positioning System) sensors, gyro sensors, acceleration sensors and the like. The sensor group 30 outputs the results of detection of the respective sensors to the display control device 50.

The cameras 40 are imaging devices that capture images by using imaging elements such as CCD (Charge Coupled Device) image sensors or CMOS (Complementary Metal Oxide Semiconductor) image sensors. The cameras 40 are provided at the front, the rear, the left side surface and the right side surface of the vehicle 10, and capture images of the periphery of the vehicle 10. For example, the images captured by the cameras 40 provided at the front of the vehicle 10 are used in order to recognize another vehicle that is traveling in front of the vehicle, the inter-vehicle distance to the other vehicle, the lanes, traffic signals, and the like. The images captured by the cameras 40 are outputted to the display control device 50. Note that the cameras 40 may be configured as imaging devices of other applications such as the drive recorder and the ADS (Advance Driver Assistance System).

The display control device 50 is, for example, an ECU (Electrical Control Unit) that carries out various types of control.

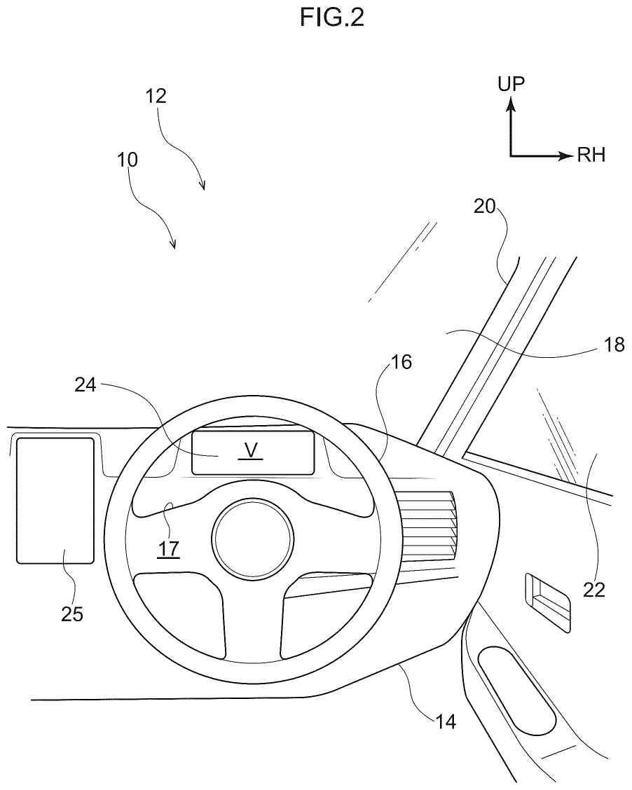

FIG. 2 is a schematic drawing in which the front section of the interior of a vehicle cabin 12 of the vehicle 10 is seen from the vehicle rear side. Arrow UP shown in FIG. 2 indicates the upper side in the vehicle vertical direction, and arrow RH indicates the right side in the vehicle transverse direction. The vertical direction and the left-right direction in the following description mean the vertical of the vehicle vertical direction and the left and right of the vehicle transverse direction.

As illustrated in FIG. 2, an instrument panel 14 is provided at the front section of the vehicle cabin 12 interior of the vehicle 10. The instrument panel 14 extends in the vehicle transverse direction, and a steering wheel 16 is provided at the vehicle right side of the instrument panel 14. Namely, the vehicle 10 is, as an example, a right-hand-drive vehicle in which the steering wheel 16 is provided at the right side, and the driver's seat is provided at the vehicle right side. Note that the present disclosure is not limited to this, and the vehicle 10 may be a left-hand-drive vehicle in which the driver's seat is provided at the vehicle left side.

A windshield glass 18 is provided at the front end section of the instrument panel 14. The windshield glass 18 extends in the vehicle vertical direction and the vehicle transverse direction, and separates the interior of the vehicle cabin 12 and the exterior of the vehicle cabin 12.

A front pillar 20 at the vehicle right side is fixed to the vehicle right side end section of the windshield glass 18. The front pillar 20 extends in the vehicle vertical direction, and the windshield glass 18 is fixed to the vehicle transverse direction inner side end section of this front pillar 20. Further, the front end section of a front side glass 22 is fixed to the vehicle transverse direction outer side end section of the front pillar 20. Note that the vehicle left side end section of the windshield glass 18 is fixed to an unillustrated front pillar that is at the vehicle left side.

Here, the first display section 24 that has a display region V for images is provided at the instrument panel 14. The first display section 24 is configured at the vehicle right side of the instrument panel 14 by a meter display that is provided at the vehicle front side of the driver's seat. The first display section 24 is connected to the various meter instruments installed in the vehicle 10, and is provided at a position that is within the field of view in the state in which the sightline of the driver is directed toward the vehicle front side. The driver is an example of the “passenger”.

The second display section 25 is provided at the instrument panel 14. The second display section 25 is configured by a center display disposed at the central portion in the vehicle transverse direction of the instrument panel 14.

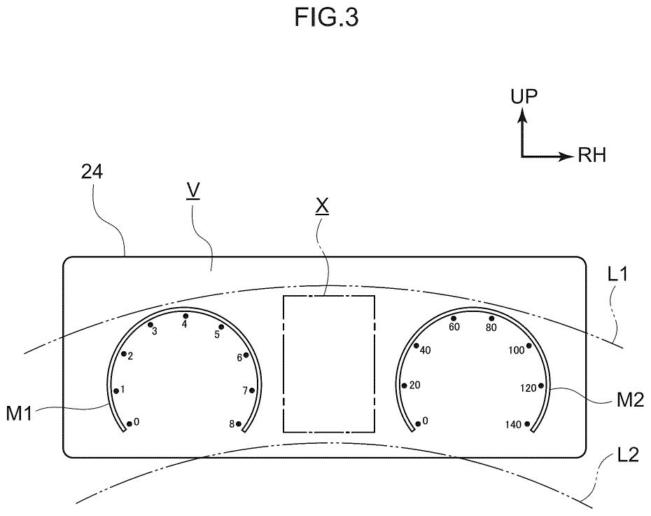

FIG. 3 is an explanatory drawing for explaining the display region of the meter display as the display region V of the first display section 24.

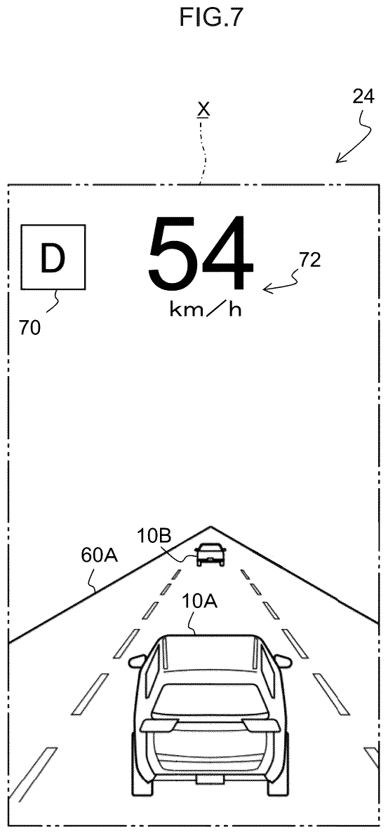

The display region V of the first display section 24 is illustrated in FIG. 3. In the present exemplary embodiment, an own vehicle image 10A (see FIG. 7 and the like) that is an image showing the vehicle 10, and peripheral situation images that are images showing the situation at the periphery of the vehicle 10, are displayed in display region X that is a partial region of the display region V. Note that specific examples of these images are described later.

The display region X is a region that the driver who is seated in the driver's seat can see through opening portion 17 (see FIG. 2) of the steering wheel 16. Specifically, as illustrated in FIG. 3, the center of the region that the driver can see from between an upper edge ridgeline L1 and a lower edge ridgeline L2 of the opening portion 17 is the display region X. Meter displays M1, M2 showing meters of measuring instruments of the vehicle 10 are displayed in the display region V at the left and the right of the display region X.

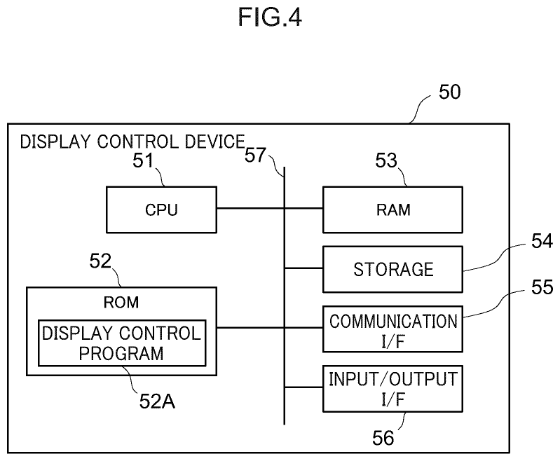

FIG. 4 is a block drawing illustrating the schematic configuration of the display control device 50. As illustrated in FIG. 4, the display control device 50 is configured to include a CPU (Central Processing Unit) 51, a ROM (Read Only Memory) 52, a RAM (Random Access Memory) 53, a storage 54, a communication I/F (Inter Face) 55, and an input/output IF 56. The CPU 51, the ROM 52, the RAM 53, the storage 54, the communication I/F 55 and the input/output I/F 56 are connected so as to be able to communicate with one another via internal bus 57.

The CPU 51 is a central computing processing unit, and executes various programs and controls respective sections. Namely, the CPU 51 reads-out programs from the ROM 52 and executes the programs by using the RAM 53 as a workspace. In the present exemplary embodiment, a display control program 52A is stored in the ROM 52.

The ROM 52 stores various programs and various data. The RAM 53 temporarily stores programs and data as a workspace.

The storage 54 is a NAND memory configured by an eMMC (embedded Multi Media Card) or a UFS (Universal Flash Storage) or the like. The storage 54 and the CPU 51 are connected by an eMMC or a UFS interface.

Respective parts of the display control device 50 such as the ROM 52 and the storage 54 are preferably tamperproof media such as HSMs (Hardware Security Modules).

The communication I/F 55 is an interface for connection with other ECUs. Communication standards in accordance with Ethernet® are used at this interface.

The input/output I/F 56 is an interface for communication with onboard devices installed in the vehicle 10 such as the display devices 21, the sensor group 30 and the cameras 40.

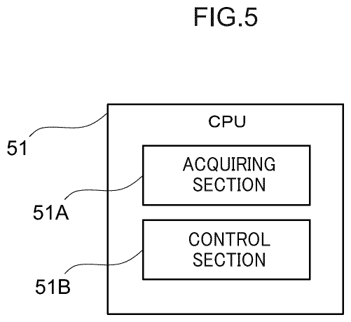

The functional configurations of the display control device 50 are described next. FIG. 5 is a block drawing illustrating an example of the functional configurations of the display control device 50.

As illustrated in FIG. 5, the CPU 51 of the display control device 50 has an acquiring section 51A and a control section 51B as the functional configurations thereof. These functional configurations are realized by the CPU 51 reading-out and executing the display control program 52A stored in the ROM 52.

The acquiring section 51A acquires various information. For example, the acquiring section 51A acquires, as the various information, peripheral information relating to the situation at the periphery of the vehicle 10. The peripheral information includes results of detection by the respective sensors structuring the sensor group 30, images captured by the cameras 40, and the like.

The control section 51B carries out display control relating to display by the display devices 21. For example, as this display control, on the basis of the peripheral information acquired by the acquiring section 51A, the control section 51B displays on the first display section 24 the own vehicle image 10A and peripheral situation images that are viewed from a virtual viewpoint. This virtual viewpoint is set in a three-dimensional virtual space whose origin is the position of the own vehicle image 10A, and is defined by the viewpoint coordinates and the viewpoint angle (orientation) in the virtual space. As an example, the virtual viewpoint is the viewpoint of viewing at a specific viewpoint angle from specific viewpoint coordinates at the upper side of the own vehicle image 10A in the virtual space.

Further, the peripheral situation images include a road image expressing the roads including the roadway on which the vehicle 10 travels and sidewalks, and target images showing targets other than the vehicle 10 such as other vehicles and pedestrians. Note that the roads shown in the road image include public roads, private roads, vacant land, public squares, parking lots and the like. The road image is an example of the “image of a background”.

On the basis of the peripheral information, the control section 51B generates images that are to be displayed on the first display section 24 and that show the vehicle 10, roads and targets, and displays the own vehicle image 10A and the target images on the road image in an arrangement based on the relationship between the actual positions thereof and from a viewpoint at which the vehicle 10 is viewed from a specific virtual viewpoint.

Further, as the aforementioned display control, the control section 51B changes the road image that is displayed as a peripheral situation image, due to the establishment of a predetermined condition. The predetermined conditions are various conditions for changing the road image displayed on the first display section 24. In the first exemplary embodiment, the control section 51B determines the establishment, or lack thereof, of the predetermined condition on the basis of the traveling place and the state of the vehicle 10. For example, the control section 51B determines that a predetermined condition has been established in a case in which the place where the vehicle 10 is traveling changes from a general road to a highway, or in a case in which the place where the vehicle 10 is traveling changes from a highway to a general road. Further, the control section 51B determines that a predetermined condition has been established in a case in which the shift position of the vehicle 10 is switched to the R position.

Here, three types of road images, which are a first road image 60A, a second road image 60B and a third road image 60C, are provided (see FIG. 7 through FIG. 9). The first road image 60A is an illustrative image in which the roads at the periphery of the vehicle 10 are drawn as straight roads or curved roads. The second road image 60B is an illustrative image in which the roads at the periphery of the vehicle 10, which are expressed by map data stored in an external server or the storage 54 or the like, are drawn by 3D modeling. The third road image 60C is a captured image of the roads at the periphery of the vehicle 10 that are captured in real time by the cameras 40.

Moreover, the control section 51B changes the virtual viewpoint in accordance with the changed road image. Here, the changing of the virtual viewpoint is the changing of at least one of the viewpoint coordinates and the viewpoint angle in the virtual space. Note that examples of changing the road image and the virtual viewpoint are described later.

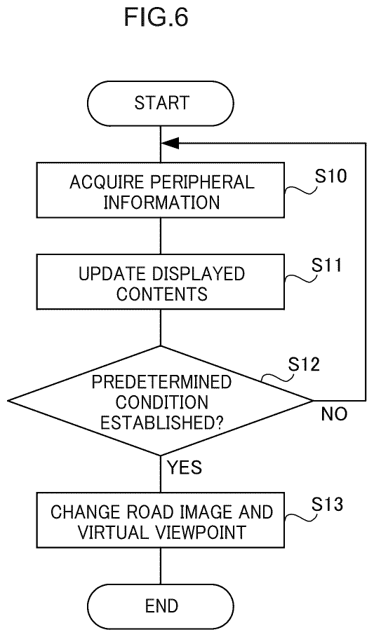

FIG. 6 is a flowchart illustrating the flow of specifying processing that is executed by the display control device 50. The specifying processing is carried out by the CPU 51 reading-out the display control program 52A from the ROM 52, and expanding and executing the program in the RAM 53. As an example, the specifying processing is repeated automatically each time a given time period elapses.

In step S10 of FIG. 6, the CPU 51 acquires peripheral information relating to the peripheral situation of the vehicle 10. Then, the CPU 51 advances to step S11.

In step S11, on the basis of the peripheral information acquired in step S10, the CPU 51 updates the displayed contents of the first display section 24. For example, in a case in which the speed of the vehicle 10 increases or decreases, the CPU 51 changes the numerical value shown as vehicle speed information 72 (see FIG. 7 through FIG. 9) that is described later and is displayed in the first display section 24. In a case in which the vehicle 10 approaches another vehicle ahead, the CPU 51 narrows the inter-vehicle distance between the own vehicle image 10A and the image showing that other vehicle in the first display section 24. Then, the CPU 51 advances to step S12.

In step S12, the CPU 51 determines whether or not a predetermined condition has been established. Here, if the CPU 51 determines that a predetermined condition has been established (step S12: YES), the CPU 51 advances to step S13. On the other hand, if the CPU 51 determines that a predetermined condition is not established (step S12: NO), the CPU 51 returns to step S10.

In step S13, the CPU 51 changes the road image that is displayed as a peripheral situation image, and changes the virtual viewpoint in accordance with the changed road image. Then, the CPU 51 ends the specifying processing.

Examples of changing the road image and the virtual viewpoint based on the establishment of a predetermined condition are described next by using FIG. 7 through FIG. 9.

FIG. 7 is a first explanatory drawing illustrating a display example that is displayed in the display region X of the first display section 24. Specifically, FIG. 7 illustrates an example of displayed contents of the display region X in a case in which the vehicle 10 is traveling on a highway.

Shift information 70 and the vehicle speed information 72 are displayed in the upper section of the display region X illustrated in FIG. 7.

The shift information 70 shows the shift position of the vehicle 10. In FIG. 7, “D” is displayed as the shift information 70 and shows that the shift position is the D position.

The vehicle speed information 72 shows the speed of the vehicle 10. In FIG. 7, “54 km/h” is displayed as the vehicle speed information 72 and shows that the vehicle speed is 54 km/h.

Further, in the display region X illustrated in FIG. 7, the own vehicle image 10A, an other vehicle image 10B and the first road image 60A are displayed beneath the shift information 70 and the vehicle speed information 72. The own vehicle image 10A is an illustrative image in which the vehicle 10 is drawn in a predetermined design. The other vehicle image 10B is an illustrative image in which another vehicle, which is positioned at the front side in the traveling direction of and in the same lane as the vehicle 10, is drawn in a predetermined design. Further, the first road image 60A illustrated in FIG. 7 is an illustrative image in which the highway on which the vehicle 10 is traveling is drawn as a straight road. On the basis of the acquired peripheral information, the CPU 51 of the display control device 50 generates the above-described own vehicle image 10A, other vehicle image 10B and first road image 60A.

Further, the CPU 51 displays the own vehicle image 10A and the other vehicle image 10B on the first road image 60A in an arrangement that is based on the actual positional relationship thereof. For example, as illustrated in FIG. 7, the CPU 51 displays the own vehicle image 10A and the other vehicle image 10B in the same lane on the first road image 60A.

Here, in FIG. 7, the CPU 51 displays, in the display region X, the own vehicle image 10A, the other vehicle image 10B and the first road image 60A at a viewpoint seen from a first virtual viewpoint that has been set for the first road image 60A. The first virtual viewpoint is a viewpoint of looking down on the own vehicle image 10A obliquely downward from a high position at the rear side in the traveling direction.

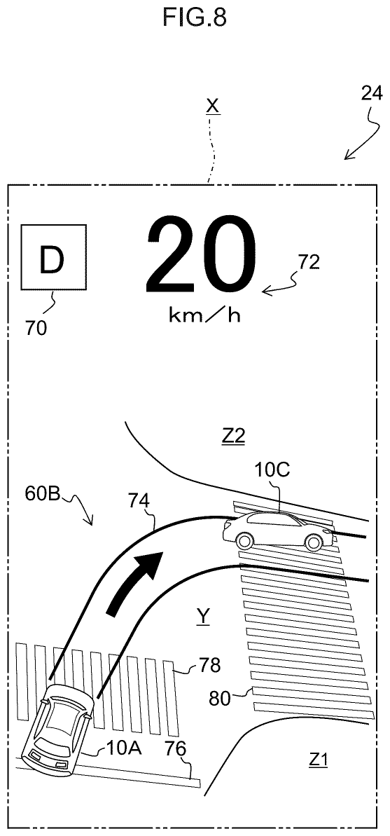

FIG. 8 is a second explanatory drawing illustrating a display example that is displayed in the display region X of the first display section 24. Specifically, FIG. 8 illustrates a first example of displayed contents of the display region X in a case in which the vehicle 10 is traveling on a general road.

The shift information 70 and the vehicle speed information 72 are displayed in the upper portion of the display region X illustrated in FIG. 8. In FIG. 8, “D” is displayed as the shift information 70 and shows that the shift position is the D position. Further, in FIG. 8, “20 km/h” is displayed as the vehicle speed information 72 and shows that the vehicle speed is 20 km/h.

Further, in the display region X illustrated in FIG. 8, the own vehicle image 10A, an other vehicle image 10C and the second road image 60B are displayed beneath the shift information 70 and the vehicle speed information 72. The other vehicle image 10C is an illustrative image in which another vehicle, which is positioned at the front side in the traveling direction of the vehicle 10, is drawn in a predetermined design. Further, the second road image 60B illustrated in FIG. 8 is an illustrative image in which the general roads in the periphery of the vehicle 10 that are expressed by map data are drawn by 3D modeling. On the basis of the fact that the traveling place of the vehicle 10 has changed from a highway to a general road and a predetermined condition has been established, the CPU 51 of the display control device 50 generates the above-described own vehicle image 10A, other vehicle image 10C and second road image 60B by using the peripheral information and map data.

The second road image 60B illustrated in FIG. 8 is sectioned into roadway Y that is a region showing a roadway, and sidewalk Z1 and sidewalk Z2 that are regions showing sidewalks. Further, route information 74, in which the route to the destination of the vehicle 10 that has been set by the car navigation system is indicated by two line segments, is displayed on the roadway Y at the traveling direction front side of the own vehicle image 10A. Further, a stop line image 76 showing a stop line and a crosswalk image 78 showing a crosswalk are displayed at portions of the roadway Y that overlap the own vehicle image 10A. A crosswalk image 80, which shows a crosswalk relating to crossing between the sidewalk Z1 and the sidewalk Z2, is displayed at a portion of the roadway Y that overlaps the other vehicle image 10C.

Further, in the same way as described above, the CPU 51 displays the own vehicle image 10A and the other vehicle image 10C on the second road image 60B in an arrangement that is based on the actual positional relationship thereof. For example, as illustrated in FIG. 8, the CPU 51 displays the other vehicle image 10C on the roadway Y at the traveling direction front side of the own vehicle image 10A.

Here, in FIG. 8, the CPU 51 displays, in the display region X, the own vehicle image 10A, the other vehicle image 10C and the second road image 60B at a viewpoint seen from a second virtual viewpoint that has been set for the second road image 60B. The second virtual viewpoint is a viewpoint of looking down on the own vehicle image 10A obliquely downward from a position that is higher than the first virtual viewpoint. In this way, because display is carried out in FIG. 8 at a viewpoint seen from the second virtual viewpoint, a broader range of the roads is displayed within the display region X as compared with the viewpoint seen from the first virtual viewpoint illustrated in FIG. 7.

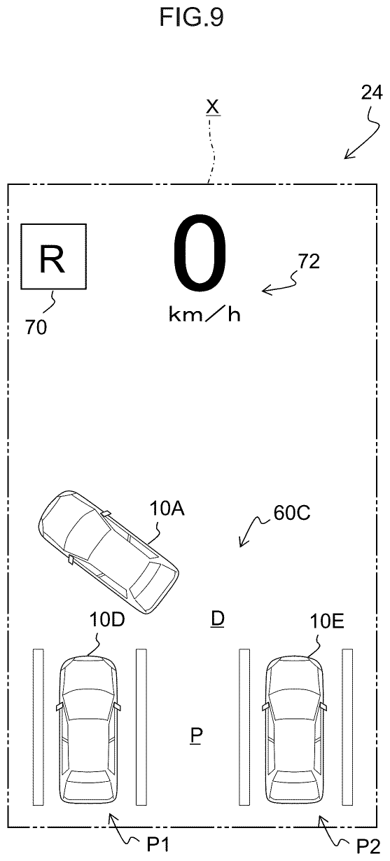

FIG. 9 is a third explanatory drawing illustrating a display example that is displayed in the display region X of the first display section 24. Specifically, FIG. 9 illustrates an example of displayed contents of the display region X in a case in which the shift position of the vehicle 10 is switched to the R position.

The shift information 70 and the vehicle speed information 72 are displayed in the upper portion of the display region X illustrated in FIG. 9. In FIG. 9, “R” is displayed as the shift information 70 and shows that the shift position is the R position. Further, in FIG. 9, “0 km/h” is displayed as the vehicle speed information 72 and shows that the vehicle speed is 0 km/h.

Further, in the display region X illustrated in FIG. 9, the own vehicle image 10A, an other vehicle image 10D, an other vehicle image 10E and the third road image 60C are displayed.

Here, the other vehicle image 10D and the other vehicle image 10E are captured images showing other vehicles that exist at the periphery of the vehicle 10, which images are captured in real time by the cameras 40. Further, the third road image 60C is a captured image showing a parking lot at the periphery of the vehicle 10, which image is captured in real time by the cameras 40. In detail, the other vehicle image 10D, the other vehicle image 10E and the third road image 60C are images in which captured images, which are captured in real time by the cameras 40, are converted into images of a viewpoint of virtually looking directly downward from the sky. Note that the own vehicle image 10A is, in the same way as described above, an illustrative image in which the vehicle 10 is drawn in a predetermined design. In this way, in the display region X illustrated in FIG. 9, the own vehicle image 10A is displayed as an illustrative image, and the other vehicle image 10D, the other vehicle image 10E and the third road image 60C are displayed as captured images. On the basis of the fact that the shift position of the vehicle 10 has been switched to the R position and a predetermined condition has been established, the CPU 51 of the display control device 50 generates the above-described own vehicle image 10A, other vehicle image 10D, other vehicle image 10E and third road image 60C on the basis of the peripheral information.

The third road image 60C illustrated in FIG. 9 is sectioned into parking space P that is a region showing a parking space in the parking lot, and traveling space D that is a region showing the traveling space in the parking lot. Further, in the same way as described above, the CPU 51 displays the own vehicle image 10A, the other vehicle image 10D and the other vehicle image 10E on the third road image 60C in an arrangement that is based on the actual positional relationship thereof. For example, as illustrated in FIG. 9, the CPU 51 displays the own vehicle image 10A in the traveling space D, and displays the other vehicle image 10D within the parking lines of parking space P1 at the left side in the drawing, and displays the other vehicle image 10E within the parking lines of parking space P2 at the right side in the drawing.

Here, in FIG. 9, the CPU 51 displays, in the display region X, the own vehicle image 10A, the other vehicle image 10D, the other vehicle image 10E and the third road image 60C at a viewpoint seen from a third virtual viewpoint that has been set for the third road image 60C. The third virtual viewpoint is a viewpoint of looking directly down on the own vehicle image 10A from a high position.

As described above, at the display control device 50, the CPU 51 displays the own vehicle image 10A and peripheral situation images of the time of viewing from a virtual viewpoint, in the first display section 24 and on the basis of peripheral information relating to the peripheral situation of the vehicle 10. Further, the CPU 51 changes the road image, which is displayed as a peripheral situation image, due to the establishment of a predetermined condition. Due thereto, in accordance with the display control device 50, by changing the road image that is displayed as a peripheral situation image due to the establishment of a predetermined condition, the road image may be presented to the driver in plural forms of before and after the change.

In the display control device 50, the CPU 51 changes the road image that is displayed on the first display section 24, due to the establishment of a predetermined condition that is based on the traveling place and the state of the vehicle 10. Further, the CPU 51 changes the virtual viewpoint in accordance with the changed road image. Due thereto, in accordance with the display control device 50, a road image, which is seen from a virtual viewpoint that is thought to be suitable in accordance with the traveling place and the state of the vehicle 10, may be presented to the driver.

Further, at the display control device 50, the first display section 24 is a meter display that is provided at the vehicle front side of the driver's seat of the vehicle 10. Due thereto, in accordance with the display control device 50, information showing meters of the measuring instruments of the vehicle 10, and the own vehicle image 10A and peripheral situation images, may be presented to the driver on one screen.

### Second Exemplary Embodiment

A second exemplary embodiment of the vehicle 10 relating to the present exemplary embodiments is described next while omitting or simplifying repeat portions of the above-described exemplary embodiment.

In the second exemplary embodiment, in addition to the case described in the above exemplary embodiment, the CPU 51 of the display control device 50 determines the establishment, or lack thereof, a predetermined condition that is based on a selection by the driver. For example, the CPU 51 determines that a predetermined condition has been established in a case in which a predetermined setting operation with respect to the vehicle 10 has been carried out by the driver.

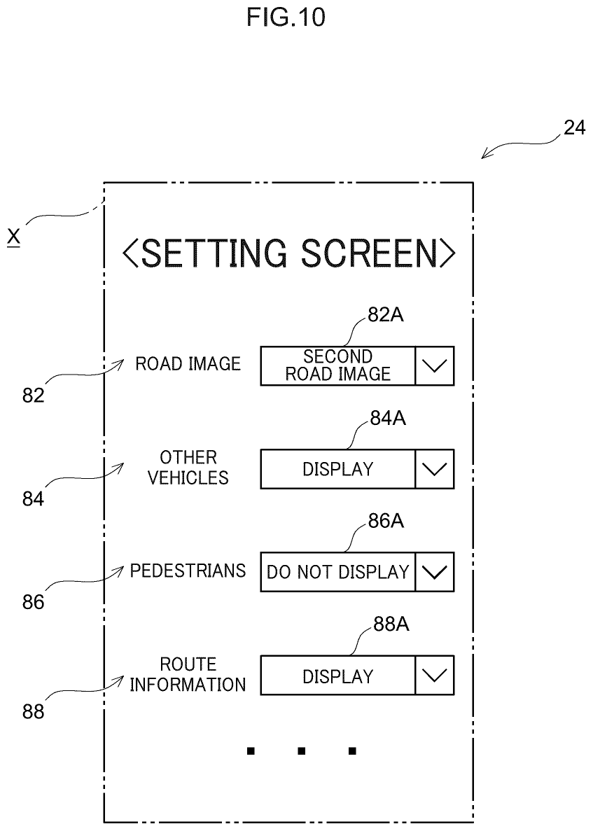

FIG. 10 is a fourth explanatory drawing illustrating a display example that is displayed in the display region X of the first display section 24. Specifically, FIG. 10 illustrates a setting screen at which it is possible to set the displaying or non-displaying and the like of the road image and individual target images that are to be displayed as peripheral situation images.

A first setting item 82, a second setting item 84, a third setting item 86 and a fourth setting item 88 are displayed in the setting screen illustrated in FIG. 10.

The first setting item 82 is a portion for setting the road image to be displayed on the first display section 24. As one example, one choice among “first road image”, “second road image” and “third road image” is set at the first setting item 82. The driver operates an unillustrated operation switch that is onboard equipment, and selects one choice from among the three choices in a pull-down menu. As an example, “second road image” is displayed in setting box 82A of the first setting item 82, and this shows that the second road image 60B is to be displayed as the road image.

The second setting item 84 is a portion for setting whether images showing other vehicles are to be displayed or are not to be displayed as individual target images.

The third setting item 86 is a portion for setting whether images showing pedestrians are to be displayed or are not to be displayed as individual target images.

The fourth setting item 88 is a portion for setting whether the route information 74 (see FIG. 8) is to be displayed or is not to be displayed on the road image.

As an example, the second setting item 84, the third setting item 86 and the fourth setting item 88 are set to either “display” or “do not display”. The driver operates the operation switch, and selects one choice among the two choices from the drop-down menus. As an example, “display” is displayed in setting box 84A of the second setting item 84, which shows that images showing other vehicles are to be displayed. Further, “do not display” is displayed in setting box 86A of the third setting item 86, which shows that images showing pedestrians are not to be displayed. Moreover, “display” is displayed in setting box 88A of the fourth setting item 88, which shows that the route information 74 is to be displayed.

After the driver selects the contents of the settings of all of the setting items in the setting screen, the driver operates the operation switch and carries out predetermined setting operations with respect to the vehicle 10. Due thereto, the CPU 51 determines that a predetermined condition that is based on a selection by the driver has been established, and changes the road image displayed on the first display section 24 to the set contents of the first setting item 82. Further, on the basis of the set contents of the second setting item 84, the third setting item 86 and the fourth setting item 88, the CPU 51 switches the displaying or non-displaying of the individual target images and the route information 74 that are to be displayed in the first display section 24.

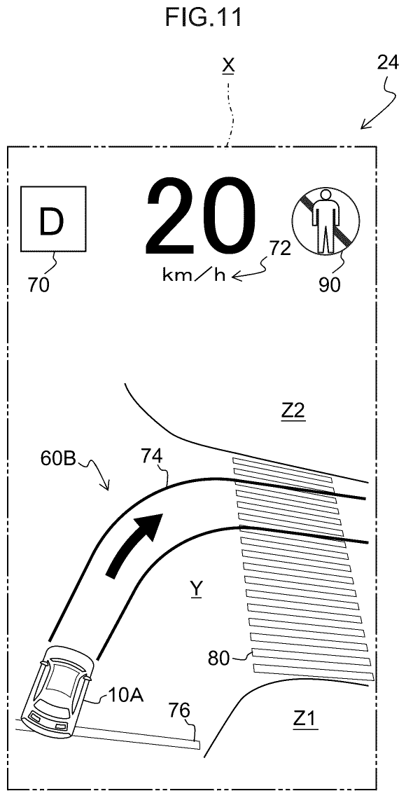

FIG. 11 is a fifth explanatory drawing illustrating a display example that is displayed in the display region X of the first display section 24. Specifically, FIG. 11 illustrates an example of displayed contents of the own vehicle image 10A and peripheral situation images that are based on the set contents that have been set in the setting screen illustrated in FIG. 10.

The shift information 70 and the vehicle speed information 72 are displayed in the upper portion of the display region X illustrated in FIG. 11. Here, caution information 90, which expresses that images showing pedestrians are not displayed as peripheral situation images, is displayed at the right side of the vehicle speed information 72 shown in FIG. 11. As an example, the caution information 90 is a design in which a diagonal line directed downward to the right is applied to an icon showing a pedestrian.

Further, in the display region X illustrated in FIG. 11, beneath the shift information 70, the vehicle speed information 72 and the caution information 90, the second road image 60B is displayed as the road image on the basis of the set contents that were set in the setting screen illustrated in FIG. 10. As an example, in the same way as in the above-described exemplary embodiment, the second road image 60B illustrated in FIG. 11 is an illustrative image in which the general roads in the periphery of the vehicle 10 that are expressed by map data are drawn by 3D modeling. In the same way as in FIG. 8, the second road image 60B is sectioned into the roadway Y, and the sidewalk Z1 and the sidewalk Z2, and the route information 74 is displayed on the roadway Y on the basis of the set contents that were set in the setting screen illustrated in FIG. 10. Further, because the setting box 86A has been set to “do not display” in the setting screen illustrated in FIG. 10, even if pedestrians in the vicinity of the vehicle 10 were to be detected on the basis of the peripheral information, images showing those pedestrians would not be displayed on this second road image 60B.

As described above, in the second exemplary embodiment, the CPU 51 of the display control device 50 displays the road image, the individual target images and the route information 74 on the first display section 24 on the basis of the set contents that were set in the setting screen illustrated in FIG. 10. Therefore, for example, even if the traveling place of the vehicle 10 changes from a general road to a highway, the CPU 51 does not change the road image to the first road image 60A as in the above-described exemplary embodiment, and displays the second road image 60B, in which the highway has been 3D-modeled on the basis of map data, in the first display section 24.

Further, in the second exemplary embodiment, as a function of the control section 51B, the CPU 51 of the display control device 50 changes the road image displayed on the first display section 24 due to the establishment of a predetermined condition that is based on a selection by the driver of the vehicle 10. Further, the CPU 51 switches the displaying or non-displaying of the individual target images that are displayed as peripheral situation images, due to the establishment of that predetermined condition. Due thereto, in accordance with this display control device 50, a road image and target images corresponding to the preferences of the driver may be presented to the driver.

Further, in the second exemplary embodiment, in a case in which images showing pedestrians are switched to non-display, the CPU 51 of the display control device 50, as a function of the control section 51B, displays on the first display section 24 the caution information 90 that expresses that images showing pedestrians are not displayed as peripheral situation images. Due thereto, in accordance with the display control device 50, even though images showing pedestrians are not displayed on the first display section 24, the driver can be made to pay attention to pedestrians existing in the real space. Images showing pedestrians are an example of the “images of a specific target”.

### Third Exemplary Embodiment

A third exemplary embodiment of the vehicle 10 relating to the present exemplary embodiments is described next while omitting or simplifying repeat portions of the above-described exemplary embodiments.

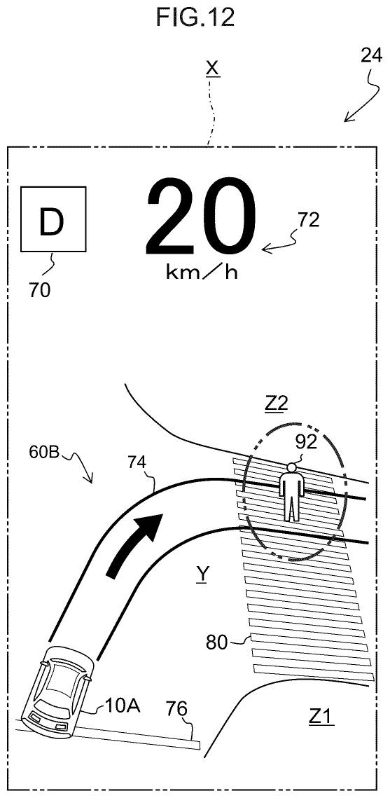

FIG. 12 is a sixth explanatory drawing illustrating a display example that is displayed in the display region X of the first display section 24. Specifically, FIG. 12 illustrates a second example of displayed contents of the display region X in a case in which the vehicle 10 is traveling on general roads.

In the same way as in the above exemplary embodiments, the shift information 70 and the vehicle speed information 72 are displayed in the upper portion of the display region X illustrated in FIG. 12.

Further, in the display region X illustrated in FIG. 12, the own vehicle image 10A, a pedestrian image 92 and the second road image 60B are displayed beneath the shift information 70 and the vehicle speed information 72. The pedestrian image 92 is an illustrative image in which a pedestrian, who is traversing a crosswalk in the vicinity of the vehicle 10, is drawn in a predetermined design. At this time, the CPU 51 displays the own vehicle image 10A and the pedestrian image 92 on the second road image 60B in an arrangement that is based on the actual positional relationship thereof. For example, as illustrated in FIG. 12, the CPU 51 displays the pedestrian image 92 within two line segments that are shown by the route information 74 of the traveling direction front side of the own vehicle image 10A on the roadway Y.

Here, in the third exemplary embodiment, in a case in which plural targets of the same type that exist within a predetermined range are detected, the CPU 51 of the display control device 50, as a function of the control section 51B, displays, on the first display section 24, only the image of a target, whose risk to the vehicle 10 exceeds a predetermined standard, among the plural targets. The predetermined range can be set appropriately, such as for example, within a radius of 2 meters, within a radius of 5 meters or within a radius of 10 meters. Further, the risk to the vehicle 10 is a degree expressing the possibility of contacting the vehicle 10. A target whose risk exceeds a predetermined standard in the third exemplary embodiment is, as an example, a target that exists on the traveling route of the vehicle 10.

The example illustrated in FIG. 12 is displayed contents of a case in which three pedestrians exist within a predetermined range, and one thereamong exists on the traveling route of the vehicle 10. In this case, the CPU 51 displays an image, which shows the one pedestrian who exists on the traveling route, as the pedestrian image 92 on the first display section 24, and images showing the other two pedestrians are not displayed on the first display section 24. Further, by displaying on the first display section 24 an oval that surrounds the periphery of the pedestrian image 92, the CPU 51 emphasizes to the driver the existence of the pedestrian on the traveling route.

As described above, in accordance with the display control device 50 relating to the third exemplary embodiment, owing to the above-described configuration, the attention paid to a target, that exists in the real space and whose risk to the vehicle 10 exceeds a predetermined standard, may be increased.

### (Other Points)

The above exemplary embodiments give examples of a predetermined condition that is based on the traveling place and the state of the vehicle 10, and a predetermined condition that is based on a selection by the driver. However, the predetermined condition is not limited to these. The predetermined condition may be established on the basis of the peripheral situation of the vehicle 10. For example, the CPU 51 may determine that a predetermined condition has been established in a case in which the amount of light received by a luminance sensor included in the sensor group 30 becomes less than a predetermined amount, or in other words, a case in which the periphery of the vehicle 10 becomes dark.

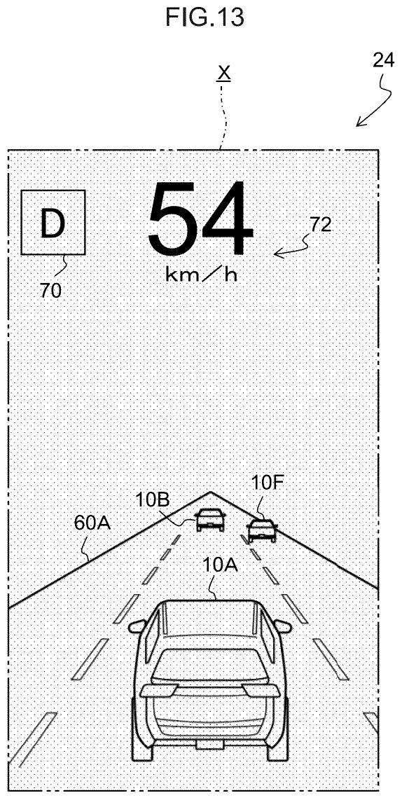

FIG. 13 is a seventh explanatory drawing illustrating a display example that is displayed in the display region X of the first display section 24. Specifically, FIG. 13 illustrates displayed contents after a predetermined time elapses from the example illustrated in FIG. 7 being displayed on the first display section 24.

In the same way as in the above exemplary embodiments, the shift information 70 and the vehicle speed information 72 are displayed in the upper portion of the display region X illustrated in FIG. 13.

Further, in the display region X illustrated in FIG. 13, the own vehicle image 10A, the other vehicle image 10B, an other vehicle image 10F and the first road image 60A are displayed beneath the shift information 70 and the vehicle speed information 72. The other vehicle image 10F is an illustrative image in which another vehicle, which is positioned at the advancing direction front side in the lane to the right of the vehicle 10, is drawn in a predetermined design.

Here, in the example illustrated in FIG. 13, the CPU 51 determines that the amount of light received by the luminance sensor has become less than a predetermined amount and determines that a predetermined condition has been established, and changes the road image that is displayed as a peripheral situation image. In this case, as an example, the CPU 51 changes the display color of the entire display region X including the road image. FIG. 13 shows that dot hatching has been applied to the entire display region X including the first road image 60A, and the display color has become a darker color as compared with before the change. In this way, the changing of the road image is not limited to changing of the image itself such as changing from the first road image 60A to the second road image 60B, and may be the changing of the displayed contents such as the color, shape or dimensions of the road image that is being displayed. Due thereto, in accordance with the display control device 50, the road image, which is displayed as a peripheral situation image, can be made to differ during time periods such as night and day for example, depending on the brightness of the periphery of the vehicle 10.

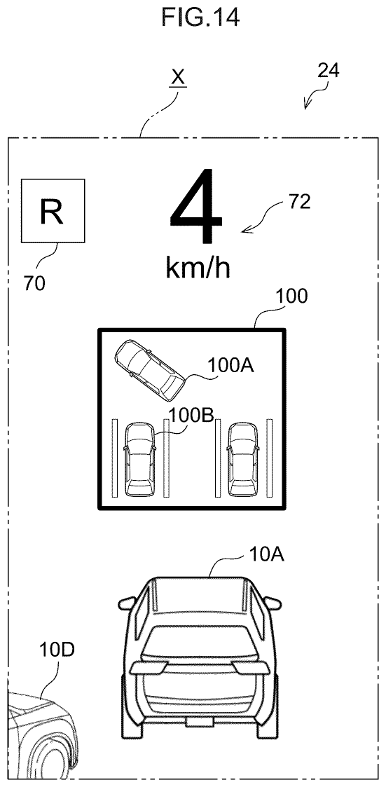

In the above exemplary embodiments, the road image that shows the road is an example of the “image of a background”, but the “image of a background” is not limited to this. For example, in addition to a road image, the “image of a background” may include a scenery image showing the scenery at the periphery of the vehicle 10, such as the ocean and mountains. If a road image and a scenery image are examples of the “image of a background”, it suffices for the changing of the image of a background to be the changing of at least one of the road image and the scenery image. Further, the “image of a background” is not limited to including a road image, and may be an image that is displayed in a region of the display region X that is other than the region in which the own vehicle image 10A, the road image and the target images are displayed. Examples thereof are described hereinafter by using FIG. 14 through FIG. 19.

FIG. 14 is an eighth explanatory drawing illustrating a display example that is displayed in the display region X of the first display section 24. Specifically, FIG. 14 illustrates an example of the displayed contents of the display region X in a case in which the shift position of the vehicle 10 is the R position.

The shift information 70 and the vehicle speed information 72 are displayed in the upper portion of the display region X illustrated in FIG. 14. In FIG. 14, “R” is displayed as the shift information 70 and shows that the shift position is the R position. Further, in FIG. 14, “4 km/h” is displayed as the vehicle speed information 72 and shows that the vehicle 10 is backing up at a vehicle speed of 4 km/h.

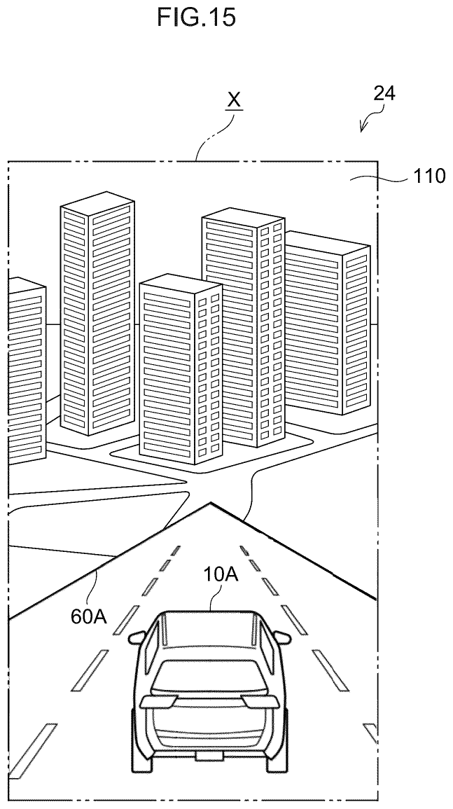

Further, the own vehicle image 10A and the other vehicle image 10D serving as a target image are displayed at the lower portion of the display region X illustrated in FIG. 14. The own vehicle image 10A illustrated in FIG. 14 is an illustrative image in which the vehicle 10 is drawn in a predetermined design. Similarly, the other vehicle image 10D illustrated in FIG. 14 is an illustrative image in which another vehicle, which is parked in the parking space adjacent to the left of the parking space that the vehicle 10 will park into, is drawn in a predetermined design. Note that the own vehicle images 10A illustrated in FIG. 15 through FIG. 19 that are described hereinafter also are illustrative images similar to that of FIG. 14.

Here, in the display region X illustrated in FIG. 14, a background image 100, which is an example of the above-described “image of a background”, is displayed in a region in the vicinity of the center between, on the one hand, the shift information 70 and the vehicle speed information 72, and on the other hand, the own vehicle image 10A and the other vehicle image 10D.

The background image 100 is a panoramic view image in which captured images of the periphery of the vehicle 10 that are captured by the cameras 40 in real time are converted into an image of a viewpoint of virtually looking down directly from the sky. For example, an image 100A showing the vehicle 10 corresponding to the own vehicle image 10A, and an image 100B showing another vehicle corresponding to the other vehicle image 10D, and the like are displayed in the background image 100. On the basis of the fact that the shift position of the vehicle 10 has been switched to the R position and a predetermined condition has been established, the CPU 51 of the display control device 50 generates and displays the above-described background image 100 on the basis of the peripheral information. Note that, in a case in which the shift position of the vehicle 10 is the P position or the D position or the like that is other than the R position, the CPU 51 either displays an image that is different than the background image 100, or does not display any image at all, in the region where the background image 100 is displayed.

FIG. 15 is a ninth explanatory drawing illustrating a display example that is displayed in the display region X of the first display section 24. Specifically, FIG. 15 illustrates an example of the displayed contents of the display region X in a case in which the vehicle 10 has left the parking space illustrated in FIG. 14 and is traveling along a general road.

The own vehicle image 10A and the first road image 60A serving as the road image are displayed in the lower portion of the display region X illustrated in FIG. 15.

Here, in the display region X illustrated in FIG. 15, a background image 110 that is an example of the above-described “image of a background” is displayed in a region other than the region in which the own vehicle image 10A and the first road image 60A are displayed.

The background image 110 is an illustrative image in which the roads, buildings and the like at the periphery of the vehicle 10, which are expressed by map data, are drawn by 3D modeling. For example, on the basis of the fact that the traveling place of the vehicle 10 has changed from a parking lot to a general road and a predetermined condition has been established, the CPU 51 of the display control device 50 generates and displays the above-described background image 110 by using the peripheral information and map data. Further, the CPU 51 changes the displayed contents of the background image 110 in accordance with the present location of the vehicle 10. For example, in a case in which the vehicle 10 turns right at an intersection, the CPU 51 changes the background image 110 to the scenery that the driver can see after turning right at that intersection.

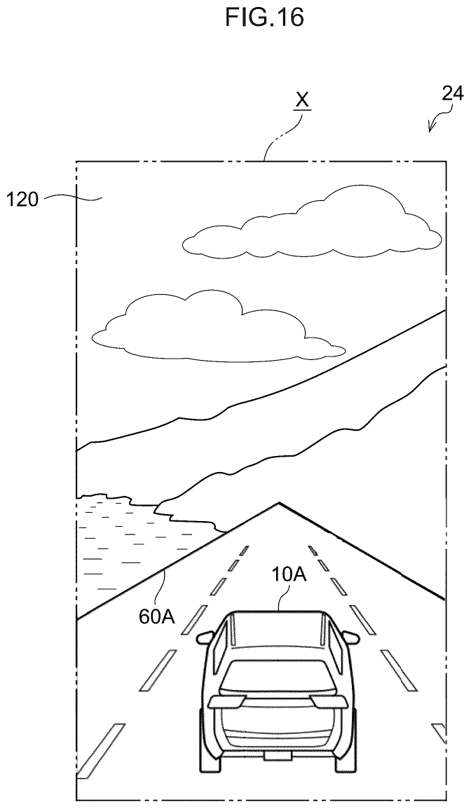

FIG. 16 is a tenth explanatory drawing illustrating a display example that is displayed in the display region X of the first display section 24. Specifically, FIG. 16 illustrates an example of displayed contents of the display region X in a case in which the traveling place of the vehicle 10 changes to a coastal road.

The own vehicle image 10A and the first road image 60A serving as the road image are displayed in the lower portion of the display region X illustrated in FIG. 16.

Here, in the display region X illustrated in FIG. 16, a background image 120 that is an example of the above-described “image of a background” is displayed in a region other than the region in which the own vehicle image 10A and the first road image 60A are displayed.

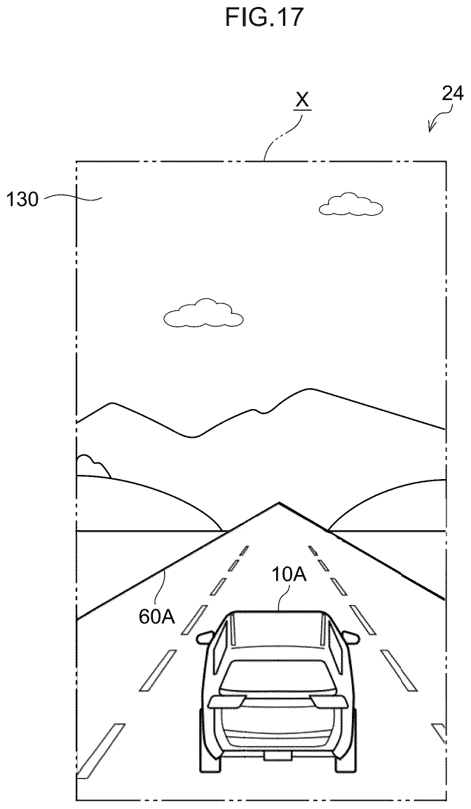

The background image 120 is an illustrative image in which the scenery of a predetermined coastal road is drawn. The background image 120 is stored in the storage 54 for example. For example, on the basis of the fact that the traveling place of the vehicle 10 has changed to a coastal road and a predetermined condition has been established, the CPU 51 of the display control device 50 acquires the background image 120 from the storage 54 and displays the background image 120. Note that which portion, among roads expressed by the map data, corresponds to the coastal road is determined in advance, and, on the basis of the peripheral information and the map data, the CPU 51 decides whether or not the traveling place of the vehicle 10 has changed to the coastal road. In this way, the image that is an example of the above-described “image of a background” may be an illustrative image that has been readied in advance. Other examples of cases in which the “image of a background” is an illustrative image that has been readied in advance are described hereinafter by using FIG. 17 through FIG. 19.

FIG. 17 is an eleventh explanatory drawing illustrating a display example that is displayed in the display region X of the first display section 24. Specifically, FIG. 17 illustrates an example of displayed contents of the display region X in a case in which the traveling place of the vehicle 10 changes to a mountain road.

The own vehicle image 10A and the first road image 60A serving as the road image are displayed in the lower portion of the display region X illustrated in FIG. 17.

Here, in the display region X illustrated in FIG. 17, a background image 130 that is an example of the above-described “image of a background” is displayed in a region other than the region in which the own vehicle image 10A and the first road image 60A are displayed.

The background image 130 is an illustrative image in which the scenery of a predetermined mountain road is drawn. The background image 130 is stored in the storage 54 for example. For example, on the basis of the fact that the traveling place of the vehicle 10 has changed to a mountain road and a predetermined condition has been established, the CPU 51 of the display control device 50 acquires the background image 130 from the storage 54 and displays the background image 130. Note that which portion, among roads expressed by the map data, corresponds to the mountain road is determined in advance, and, on the basis of the peripheral information and the map data, the CPU 51 decides whether or not the traveling place of the vehicle 10 has changed to the mountain road.

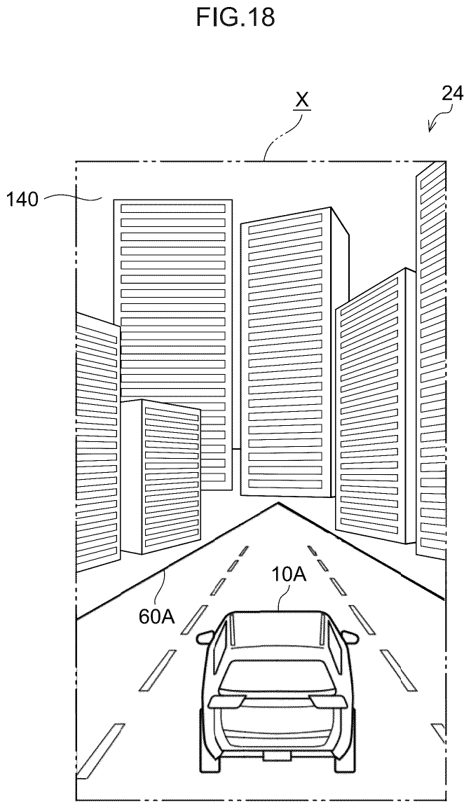

FIG. 18 is a twelfth explanatory drawing illustrating a display example that is displayed in the display region X of the first display section 24. Specifically, FIG. 18 illustrates an example of displayed contents of the display region X in a case in which the traveling place of the vehicle 10 changes to a road in an urban area.

The own vehicle image 10A and the first road image 60A serving as the road image are displayed in the lower portion of the display region X illustrated in FIG. 18.

Here, in the display region X illustrated in FIG. 18, a background image 140 that is an example of the above-described “image of a background” is displayed in a region other than the region in which the own vehicle image 10A and the first road image 60A are displayed.

The background image 140 is an illustrative image in which the scenery of a predetermined road in an urban area is drawn. The background image 140 is stored in the storage 54 for example. For example, on the basis of the fact that the traveling place of the vehicle 10 has changed to a road in an urban area and a predetermined condition has been established, the CPU 51 of the display control device 50 acquires the background image 140 from the storage 54 and displays the background image 140. Note that which portion, among roads expressed by the map data, corresponds to the road in an urban area is determined in advance, and, on the basis of the peripheral information and the map data, the CPU 51 decides whether or not the traveling place of the vehicle 10 has changed to the road in an urban area.

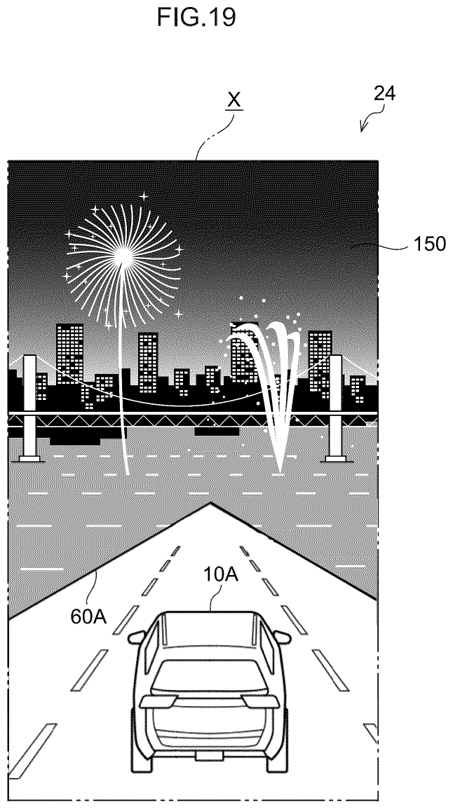

FIG. 19 is a thirteenth explanatory drawing illustrating a display example that is displayed in the display region X of the first display section 24. Specifically, FIG. 19 illustrates an example of displayed contents of the display region X in a case in which the traveling time period in which the vehicle 10 is traveling changes to nighttime.

The own vehicle image 10A and the first road image 60A serving as the road image are displayed in the lower portion of the display region X illustrated in FIG. 19.

Here, in the display region X illustrated in FIG. 19, a background image 150 that is an example of the above-described “image of a background” is displayed in a region other than the region in which the own vehicle image 10A and the first road image 60A are displayed.

The background image 150 is an illustrative image in which a predetermined nighttime scenery is drawn. The background image 150 is stored in the storage 54 for example. For example, on the basis of it being determined that a predetermined condition based on the peripheral situation of the vehicle 10 has been established, the CPU 51 of the display control device 50 acquires the background image 150 from the storage 54 and displays the background image 150. In this case, the CPU 51 may determine that a predetermined condition has been established in a case in which the amount of light received by a luminance sensor becomes less than a predetermined amount and it is assumed that the traveling time period has changed to nighttime.

In the above-described exemplary embodiments, the CPU 51 determines whether or not a predetermined condition, which is based on both the traveling place and the state of the vehicle 10, has been established. However, the present disclosure is not limited to this, and the CPU 51 may determine only whether or not a predetermined condition that is based on the traveling place of the vehicle 10 has been established, or may determine only whether or not a predetermined condition that is based on the state of the vehicle 10 has been established.

In the above-described exemplary embodiments, the CPU 51 determines that a predetermined condition has been established in a case in which the traveling place of the vehicle 10 changes from a general road to a highway, or in a case in which the traveling place of the vehicle 10 changes from a highway to a general road. However, the present disclosure is not limited to this, and, for example, the CPU 51 may determine that a predetermined condition has been established in a case in which the traveling place of the vehicle 10 enters into a traveling area that has been registered by the driver.

In the above-described exemplary embodiments, the CPU 51 determines that a predetermined condition has been established in a case in which the shift position of the vehicle 10 is switched to the R position. However, the present disclosure is not limited to this. For example, the CPU 51 may determine that a predetermined condition has been established in a case in which the vehicle 10 changes from a state of manual driving to a state of automatic driving, or in a case in which the vehicle 10 changes from a state of automatic driving to a state of manual driving.

In the above-described exemplary embodiments, the types of the individual targets, for which displaying or non-displaying of images to be displayed as the peripheral situation images can be switched, are not limited to those shown in FIG. 10. For example, in addition to those shown in FIG. 10, these targets may include other types such as obstacles, road signs or animals. Further, although all of the types of the target images are the subjects of switching between display and non-display in the above-described exemplary embodiments, there may be targets of a type that cannot be switched to non-display. For example, other vehicles may be targets of a type that cannot be switched to not being displayed and for which target images are always displayed.

In the above-described exemplary embodiments, images showing pedestrians are an example of the “images of a specific target”, but the “images of a specific target” are not limited to this. The “images of a specific target” may be images showing another type of target such as other vehicles or animals. Further, although the caution information 90 is configured by an image of a predetermined design in the above-described exemplary embodiments, the displayed contents of the caution information 90 are not limited to this. The caution information 90 may be information in which the fact that the “images of a specific target” are not displayed as peripheral situation images is expressed by words, or may be information in which this fact is expressed by words and an image.

In the above-described exemplary embodiments, the example of the targets of the same type is the plural pedestrians, but the targets of the same type is not limited to this. For example, in a case in which passenger cars and two-wheelers exist within a predetermined range, the example of the targets of the same type is not limited to the same targets, and passenger cars and two-wheelers may be considered as being targets of the same type that is “other vehicles”.

In the above-described exemplary embodiments, a target at which the risk exceeds a predetermined standard (hereinafter called a “high risk target”) is a target existing on the traveling route of the vehicle 10, but high risk targets are not limited to this. For example, a high risk target may be a target whose distance from the vehicle 10 is a predetermined value or less, or may be the target that is the shortest distance from the vehicle 10. Further, the above-described exemplary embodiments exemplify a case in which one high risk target is detected, but if plural high risk targets are detected, images expressing the plural high risk targets are displayed in the first display section 24. Moreover, in the above-described exemplary embodiments, among the targets of the same type that exist within a predetermined range, targets that are other than a high risk target are not displayed in the first display section 24, but the present disclosure is not limited to this, and these targets also may be displayed together therewith. In this case, it is preferable that the CPU 51 display images showing the high risk target and these targets by different displayed contents. Due thereto, in accordance with the display control device 50, the driver who is looking at the first display section 24 can be made to understand the risks of the respective targets with respect to the vehicle 10 on the basis of the difference in the displayed contents.

In the above-described exemplary embodiments, the first display section 24 that is a meter display is an example of the “display section”, but examples of the “display section” are not limited to a meter display. For example, examples of the “display section” may be other displays such as a center display or a head-up display (HUD). Further, examples of the “display section” may be a combination of plural displays such as a meter display and a center display.

In the above-described exemplary embodiments, the display control device 50 executes the specifying processing shown in FIG. 6. However, the present disclosure is not limited to this, and the specifying processing may be executed by the display control device 50 and another ECU in cooperation with one another. An example is a case in which, of the display devices 21, the display control device 50 controls the first display section 24, and another ECU controls the second display section 25, and the results of the specifying processing are displayed on the first display section 24 and the second display section 25. In this case, the plural ECUs that are the display control device 50 and another ECU may execute the specifying processing in cooperation with one another, or either ECU among the display control device 50 and another ECU may representatively execute the specifying processing.

Note that the specifying processing, which is executed by the CPU 51 reading-in software (a program) in the above-described exemplary embodiments, may be executed by any of various types of processors other than a CPU. Examples of processors in this case include PLDs (Programmable Logic Devices) whose circuit configuration can be changed after production such as FPGAs (Field-Programmable Gate Arrays), and dedicated electrical circuits that are processors having circuit configurations that are designed for the sole purpose of executing specific processings such as ASICs (Application Specific Integrated Circuits). Further, the specifying processing may be executed by one of these various types of processors, or may be executed by a combination of two or more of the same type or different types of processors (e.g., plural FPGAs, or a combination of a CPU and an FPGA). Further, the hardware configurations of these various types of processors are, more specifically, electrical circuits that combine circuit elements such as semiconductor elements.

Further, the above exemplary embodiments describe a form in which the display control program 52A is stored in advance (is installed) in the ROM 52, but the present disclosure is not limited to this. The display control program 52A may be provided in a form of being recorded on a recording medium such as a CD-ROM (Compact Disk Read Only Memory), a DVD-ROM (Digital Versatile Disk Read Only Memory), or a USB (Universal Serial Bus) memory. Further, the display control program 52A may be in a form of being downloaded over a network from an external device.

What is claimed is:

1. A display control device comprising:
a memory; and
a processor coupled to the memory and to a display section, the processor being configured to:
on the basis of peripheral information relating to a peripheral situation of an own vehicle, display, on the display section, images showing the own vehicle and the peripheral situation that are viewed from a virtual viewpoint, and
due to establishment of a predetermined condition, change an image of a background that is displayed as an image showing the peripheral situation.

2. The display control device of claim 1, wherein the processor being configured to:
due to establishment of the predetermined condition that is based on at least one of a traveling place or a state of the own vehicle, change the image of a background that is displayed on the display section, and
change the virtual viewpoint in accordance with the changed image of a background.

3. The display control device of claim 1, wherein the processor being configured to:
due to establishment of the predetermined condition that is based on a selection by a passenger of the own vehicle, change the image of a background that is displayed on the display section, and
switch displaying/non-displaying of images of individual targets that are displayed as images showing the peripheral situation.

4. The display control device of claim 3, wherein the processor being configured to, in a case in which images of a specific target have been switched to non-display, display, on the display section, caution information expressing that the images of the specific target are not displayed as images showing the peripheral situation.

5. The display control device of claim 3, wherein the processor being configured to, in a case in which a plurality of targets of a same type that exist within a predetermined range are detected, display on the display section only an image of a target, whose risk to the own vehicle exceeds a predetermined standard, among the plurality of targets.

6. The display control device of claim 1, wherein the display section is a meter display provided at a vehicle front side of a driver's seat of the own vehicle.

7. A display control method, comprising, by a computer:
on the basis of peripheral information relating to a peripheral situation of an own vehicle, displaying, on a display section, images showing the own vehicle and the peripheral situation that are viewed from a virtual viewpoint; and
due to establishment of a predetermined condition, changing an image of a background that is displayed as an image showing the peripheral situation.

8. A non-transitory computer-readable medium storing a display control program executable by a computer to perform processing comprising:
on the basis of peripheral information relating to a peripheral situation of an own vehicle, displaying, on a display section, images showing the own vehicle and the peripheral situation that are viewed from a virtual viewpoint; and
due to establishment of a predetermined condition, changing an image of a background that is displayed as an image showing the peripheral situation.
